(19) United States
(12) Patent Application Publication
(10) Pub. No.: US 2007/0175238 A1
(43) Pub. Date: Aug. 2, 2007

(54) Portable system for preserving labile materials

(76) Inventors: Pamela S. Norwood, Silver Spring, MD (US); Lorraine Jones, Laurel, MD (US); Blythe Joy Patenaude, Ft. Washington, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/700,848

(22) Filed: Feb. 1, 2007

Related U.S. Application Data
(60) Provisional application No. 60/764,320, filed on Feb. 2, 2006.

(51) Int. Cl. F25D 3/08; B67D 5/62

(52) U.S. Cl. 62/457.3; 62/389

(57) ABSTRACT

A container system with rigid and flexible components has a rigid container including a lower insulated storage portion and an upper storage portion configured to close and insulate the lower portion. The upper storage portion has a removable lid for quick access. The upper storage portion is removably attached to the lower portion to allow access when needed. The flexible component is configured to be combined with the rigid container by placing the rigid container in an upper pouch in the flexible component. The flexible component is further configured to contain ice and to selectively remove any melted ice via an inner lining to allow a user access to drinkable water when needed.

### CROSS-REFERENCE TO RELATED APPLICATION

This patent application claims the benefits of priority under 35 U.S.C. §§ 119, 120 to U.S. Provisional Patent Application No. 60/764,320, entitled PORTABLE SURVIVAL SYSTEM, filed on Feb. 2, 2006, the entirety of which is incorporated herein by reference.

### DESCRIPTION OF THE INVENTION

1. Field of the Invention

The present invention relates generally to storage devices. More particularly, the present invention relates to storage containers for medical and/or other emergency-related needs, such as for containing temperature-sensitive medicines and other labile materials and retaining water and ice.

2. Background of the Invention

There are significant problems attendant to transporting, maintaining and storing thermally sensitive materials like pharmaceuticals, biologicals, and organs. See A. J. McLaren and P. J. Friend, “Trends in Organ Preservation,” Transplant International, October 2003. The problem of temperature maintenance is compounded by the hazard of breakage when a glass container retains temperature sensitive material. Further, the incidence of spoilage and breakage dramatically increases when one conveys containers over long distances or time periods without refrigeration access. During emergency situations, without refrigeration, medical supplies are frequently lost because of exposure to extreme temperatures, either high or low. Exposure to sub-ambient temperatures often results in the loss of many medications. Moreover, organs frequently experience freezer burn when transported with dry ice. Eliminating the need to use dry ice saves valuable preparation time for surgeons who transplant organs, digits, or tissue. The objective for maintaining pharmaceutical preparations and organs, digits, and tissue, therefore, is to maintain an acceptable temperature range for a period of time.

During emergency situations such as floods, hurricanes, or extended power outages, an individual may be without access to proper refrigeration for labile materials for a long time, and the labile materials may face unexpected exposure to extremes in temperature. In such situations the individual may have medical needs that require medicines that must be kept cooled.

Hence, there has been a longstanding need to provide packaging that can maintain its contents at an acceptable temperature range for a period of time while comporting with the size and weight limitations of the user.

There are many containers for transporting medicines, biologicals, and temperature-sensitive materials. Containers in accordance with the prior art are designed for transporting a particular product like insulin. Heretofore, there has been no single container that can successfully maintain and transport a variety of labile materials. In order to fulfill the requisites for multi-product shipping, a container must be adapted to transport not only insulin and oncology drugs, but also other materials like biologically active proteins, which may be susceptible to irreversible physicochemical alteration upon freezing, and medicaments that lose efficacy upon exposure to elevated temperatures. The remaining unsolved problem is to design a container capable of substantially maintaining its inner environment at a temperature that preserves the enclosed materials, notwithstanding temperature changes outside the container, while being dimensionally acceptable to the user.

Another problem, long recognized yet remaining unsolved, is to provide a container that not only maintains the product safely during emergencies, but also provides a temperature controlled environment at the point of usage. For example, the container must safely hold an oncology drug in a doctor's office and must safely hold insulin vials or pens when transferred to the patient in a remote location.

### SUMMARY OF THE INVENTION

In accordance with the invention, a container system includes a rigid container comprising a lower insulated storage portion having an upper opening for removably containing labile materials and an upper storage portion that is removably attached to the lower insulated storage portion. The upper storage portion is configured to close the upper opening of and insulate the lower insulated storage portion. Additionally, the rigid container may include a lid that is removably disposed on the upper storage portion and a carry handle connected to the upper storage portion for selectively carrying the assembled rigid container.

Also in accordance with the invention, a container system includes a flexible component comprising a flexible outer bag with a closeable opening that defines a space for containing a liquid. The flexible component may also include a porous inner bag for containing ice and an upper pouch of flexible material, attached to the flexible outer bag, for containing a rigid container.

In accordance with the invention, a container system includes both a rigid container and a flexible component, wherein the rigid container comprises a lower insulated storage portion having an upper opening for removably containing labile material and an upper storage portion that is removably attached to the lower insulated storage portion. The upper storage portion may be configured to close the upper opening of the lower insulated storage portion and insulate the lower insulated storage portion. Additionally, the system includes a flexible outer bag having a closeable opening that defines a space for containing a liquid and a porous inner bag for containing ice. The system may include an upper pouch of flexible material, attached to the flexible outer bag, for containing the rigid container comprising the lower insulated storage portion, the upper storage portion, the lid, and the carry handle.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

The accompanying drawings, which are incorporated in and constitute a part of this specification, illustrate embodiments of the invention and together with the description, serve to explain the principles of the invention.

As such, those skilled in the art will appreciate that the conception upon which this disclosure is based may readily be utilized as a basis for designing other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view depicting a rigid container according to an embodiment of the present invention.

FIG. 2 is an exploded view of the rigid container of FIG. 1.

FIG. 3 is a perspective view depicting a flexible component according to an embodiment of the present invention.

FIG. 4 is a perspective view depicting the rigid container of FIG. 1 inside the flexible component of FIG. 3, according to an embodiment of the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

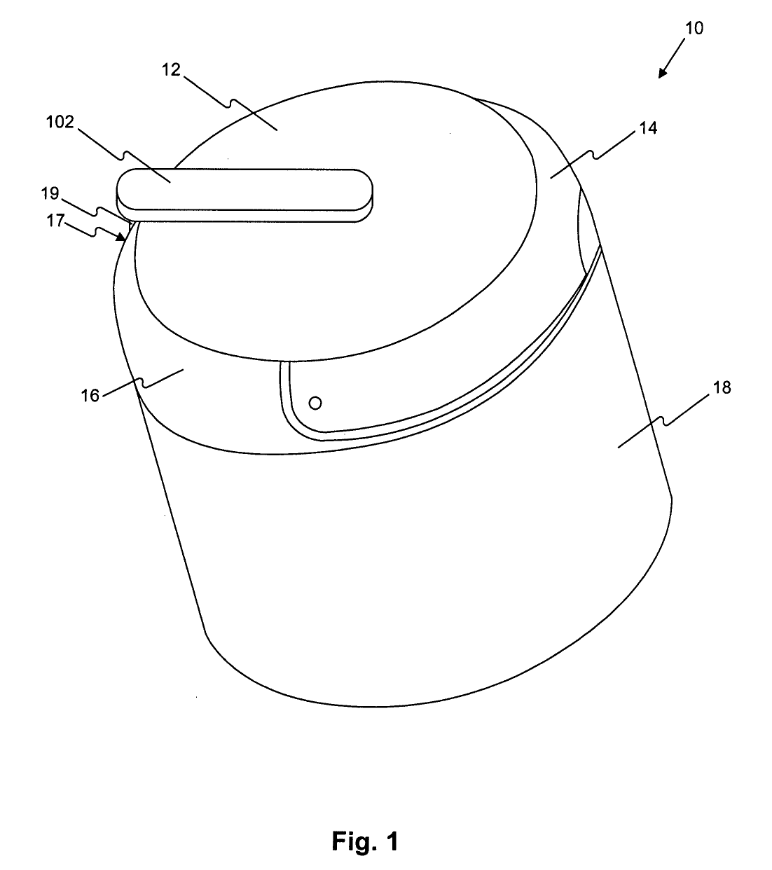

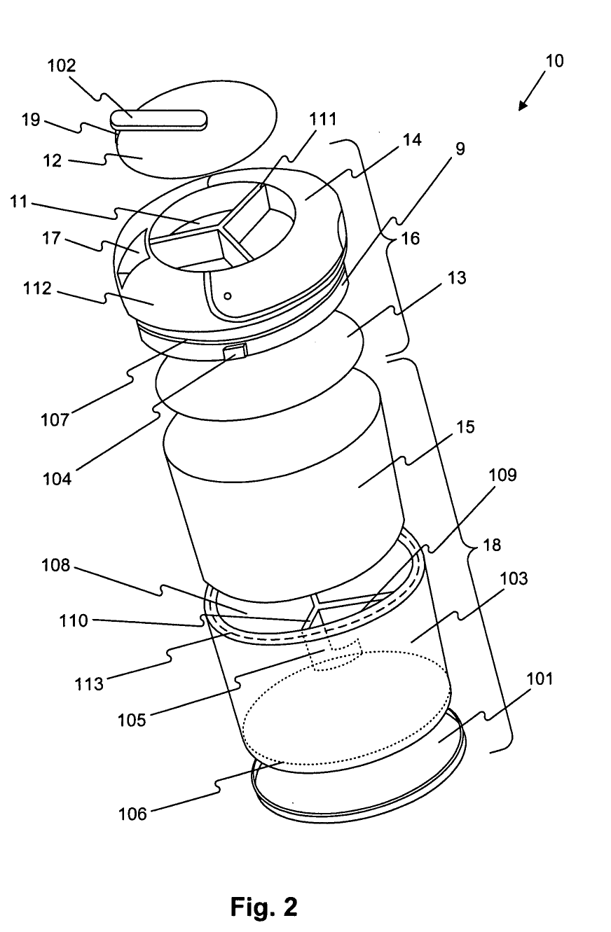

In accordance with the invention, the container system has a rigid container comprising a lower insulated storage portion. As embodied herein and depicted in FIGS. 1 and 2, the rigid container 10 comprises lower insulated storage portion 18 having a side wall 103 and a bottom wall 101 defining lower storage area 109 accessible through upper opening 108. Labile material may be removably disposed in lower storage area 109.

Preferably, as embodied herein, side wall 103 comprises two parallel walls defining a void 113 for containing insulating material 15, which may be any common form of insulation or a coolant gel, for example, Ameri-Gel. Side wall 103 may also comprise a single wall, and insulation or coolant gel may be provided in separate packets (not shown). Preferably, insulating material 15 is non-toxic and will last up to five years without leeching through side wall 103. Insulating material 15 may help maintain lower storage area 109 at a constant temperature over a period of time in ambient conditions. The double-walled lower insulated storage portion 18 may be formed using a multi-step injection/rapid mold process that creates a cavity into which insulating material 15 may be injected, and the cavity may then be sealed.

In the preferred embodiment, lower insulated storage portion 18 has a generally cylindrical shape, although other shapes may be used.

Bottom wall 101 of the depicted embodiment of lower storage portion 18 may be removable. For example, bottom wall 101 may snap fit into a circumferential groove 106 in the side wall 103 opposite opening 108. Bottom wall 101 may also be sealed in groove 106 using any conventional adhesive. Bottom wall 101 may comprise two parallel walls filled with an insulating material (not shown) such as Ameri-Gel or any other common form of insulation or coolant gel. Alternatively, bottom wall 101 and side wall 103 may be formed as a single piece.

Additionally, it may be preferred to include a section divider 110 in lower storage area 109, providing separate compartments for preventing damage to items in the storage area or providing separate areas for different items. The number of compartments formed by section divider 110 is a matter of choice. Preferably, section divider 110 is removable in the event that a larger, single compartment is needed. Section divider 110 may separate, for example, insulin from syringes, as needed.

In accordance with the invention, the rigid container of the container system further comprises an upper storage portion removably attached to the lower insulated storage portion. As embodied herein and depicted in FIGS. 1 and 2, rigid container 10 comprises upper storage portion 16 that is configured to removably close opening 108 in lower insulated storage portion 18. In the embodiment depicted herein, upper storage portion 16 comprises a body 9 and an annular collar 112 defining an upper storage area 11 and configured to sealably fit into opening 108 of lower insulated storage portion to close the opening and to provide upper insulation for lower storage area 109.

It may be preferred to include insulating material 13 in the bottom of body 9 to provide greater insulation to lower storage area 109. Insulating material 13 may be any common form of insulation or a coolant gel, for example, Ameri-Gel. Preferably, insulating material 13 is non-toxic and will last approximately five years without leeching through the bottom of body 9.

Upper storage area 11 may be configured to store temperature-sensitive items, such as medicine, in a cool environment, or store other items such as pills, gauze pads, bandages, syringes, or emergency food supplies. Upper storage area 11 may also be made of a food/health grade resin approved by the FDA such that it can store and serve food and can be cleaned easily. It may be preferred to include removable section divider 111 in upper storage area 11 to create compartments for containing various items.

In the preferred embodiment, upper storage portion 16 has a generally cylindrical shape, although other shapes may be used.

In the preferred embodiment of upper storage portion 16, means are provided to secure body 9 in opening 108. As depicted in FIG. 2, body 9 includes at least one lug 104 radially projecting from body 9 proximate the bottom thereof. For balance and greater security, a pair of radially opposed lugs 104 would be preferred. Lugs 104 are disposed to selectively engage complementary notches 105 in the upper edge of wall 103 of lower insulated storage portion 18. As depicted herein, notches 105 are L-shaped to permit insertion of lugs 104 and rotation of upper storage portion 16 to lock the two portions together. Upper storage portion 16 may also be configured to screw onto lower insulated storage portion 18 using threads (not shown) along body 9 that mate with threads (not shown) near the upper edge of wall 103. Any other conventional removable attaching means may also be used.

Also in the preferred embodiment of upper storage portion 16, seal or gasket 107 is disposed in an annular groove in body 9 sufficiently proximate to the bottom of body 9 to sealingly engage the inside of wall 103 when body 9 is disposed in opening 108 in lower insulated storage portion 18. Seal or gasket 107 may minimize heat transfer between the outside and the lower storage area 109 and deter environmental agents from entering lower storage area 109.

Also in accordance with the invention, the rigid container of the container system comprises a lid removably disposed on the upper storage portion. As embodied herein, lid 12 is disposed to enclose upper storage area 11. Lid 12 may contain latch 19 to secure it to body 9. Latch 19 may engage collar 112, for example by engaging hollow 17. Lid 12 may also contain a member for gripping 102 to facilitate gripping the lid for removal or replacement.

The rigid container of the invention also comprises a carry handle connected to the upper storage portion for selectively carrying the assembled rigid container. In the preferred embodiment, carry handle 14 is pivotally attached to body 9 for movement from a recessed position to an extended position. Collar 112 may include a recess for receiving handle 14 when in the recessed position. Such a configuration for carry handle 14 may provide a wider handle with an easier grip for users with difficulty handling items. Carry handle 14 also may provide an easy grip for detaching upper storage portion 16 from lower insulated storage portion 18. When in the recessed position, optionally snapped in so that it does not accidentally swing to the extended position, carry handle 14 may contribute to the insulation of upper storage portion 16, keeping the upper storage area 11 cool for a longer period of time.

Rigid container 10 preferably has a diameter of 7½ inches and a height of 5¼ inches. These dimensions allow rigid container 10 to store a long-term supply of prepackaged medicines that need cooling to maintain their biological integrity while allowing the user to carry rigid container 10 easily.

The rigid container 10 may be placed in a refrigeration unit (not shown) prior to use in order to achieve a desired cooled state. This will activate the insulating material 13, 15. Once properly cooled, the rigid container 10 may be taken to remote locations, maintaining a cooled condition for a number of hours without the need for refrigeration. Rigid container 10 may comprise an FDA-approved resin, and it preferably can withstand ambient temperatures varying from −10 degrees Fahrenheit up to the melting point of the material. Rigid container 10 preferably comprises polypropylene or plastic, although other materials may be used. The materials used in the rigid container 10 may make it resistant to environmental leaks and leeching.

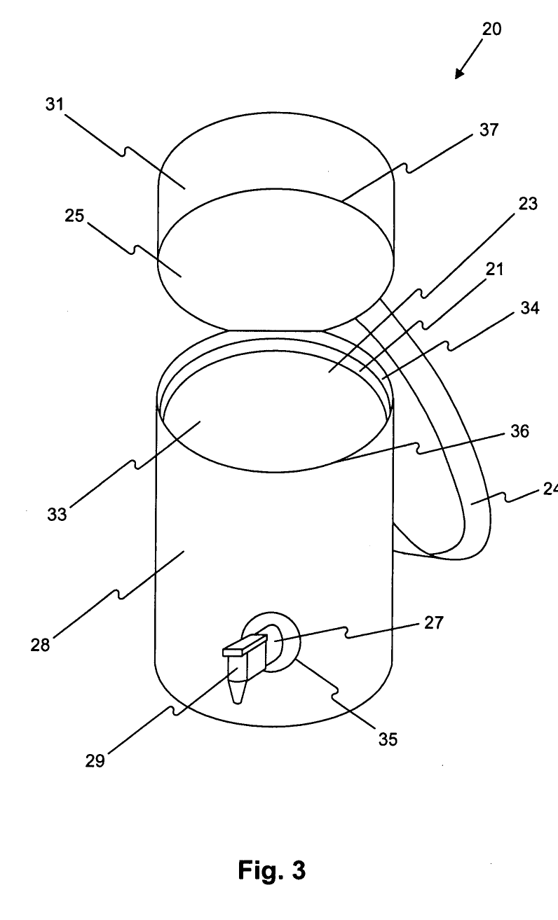

In accordance with the invention, the container system comprises a flexible component that includes a flexible outer bag with a closeable opening, together defining a space for containing a liquid. As embodied herein and depicted in FIG. 3, the flexible component 20 comprises flexible outer bag 28 that defines an enclosable space 33. Outer bag 28 is preferably cylindrical and may be made of Cordura® or another material. A waterproof and durable material is preferred, but other materials may be used.

A carrying strap 24 may be attached to the outside of flexible outer bag 28. The carrying strap 24 may comprise a single strap or a pair of straps (not shown) that allow the flexible component 20 to be carried like a backpack, duffle, or shoulder bag. The carrying strap(s) 24 may be adjustable using a D ring (not shown) or any other conventional adjustment mechanism.

The flexible component 20 may optionally have outside and/or inside storage pockets (not shown) on the flexible outer bag 28.

The flexible outer bag 28 may comprise at least two layers of material for providing additional insulation. The two layers 21, 34 of flexible outer bag 28 may include a rugged outer shell 34 that resists normal wear and tear and a lighter weight insulation layer 21 for slowing melting of ice placed in the porous inner bag in order to provide extended cooling over time. Insulation layer 21 may comprise plastic or any other waterproof material. Any or all of the layers may be made of a material that is FDA-approved for carrying potable water. Insulation layer 21 may close at the top with a fastening fixture (not shown).

Also in accordance with the invention, the flexible component includes a porous inner bag for containing ice. The porous inner bag 23 may be configured to insulate the enclosable space in order to maintain ice and cool temperatures. The porous inner bag 23 may further be configured to filter any melted ice for drinking or other purposes. Porous inner bag 23 is preferably made of a material that is FDA-approved for carrying potable water. Porous inner bag 23 may be made of moleskin or the like to provide strength and a filter for the melted ice. The melted ice may pass through the porous inner bag 23 and into a space (not shown) between the porous inner bag 23 and the flexible outer bag 28. Porous inner bag 23 may attach to flexible outer bag 28 at the top, anywhere within the flexible component 20, or porous inner bag 23 and flexible outer bag 28 may be completely separate. Porous inner bag 23 may close at the top with a fastening fixture (not shown).

A tube provides fluid communication with the space between the porous inner bag and the flexible outer bag for selectively removing water accumulating therein. The tube 27 extends from and provides fluid communication with the space (not shown) between the porous inner bag 23 and the flexible outer bag 28. For example, the tube 27 may be affixed to a hole in the outer shell 34 of the flexible outer bag 28 such that water can flow out of the hole and into the tube. If insulation layer 21 is included, tube 27 may be affixed to a hole in insulation layer 21 and passed through a hole in outer shell 34. A grommet 35 may surround the hole in outer shell 34. The melted ice remains within the outer shell 34, or the insulation layer 21 if included, until accessed by a user optionally via the tube 27 when needed. Alternatively, the water may be accessed using a cup (not shown) to scoop water from the inside of the outer shell 34 or insulation layer 21.

Tube 27 includes a spout with a twisting shutoff valve 29 for transporting water out of the flexible component. Shutoff valve 29, when open, allows water to flow through the tube 27 to the user who can drink it or use it for any other conventional purpose. Alternate mechanisms may also be used to allow the water to flow. A separate cup, bag, or other drinking vessel (not shown) may be provided in the flexible component 20 to be removed and used for catching and drinking the water once it flows out through shutoff valve 29.

Also in accordance with the invention, the flexible component 20 includes an upper pouch 31 of flexible material, attached to the flexible outer bag 28, for containing a rigid container. The upper pouch 31 is configured to store/hold its contents in close proximity to the ice. Upper pouch 31 comprises a side wall 32 and a bottom 25 defining an enclosable space 26 for containing a rigid container. Upper pouch 31 is configured to cover and close lower enclosable space 33. A zipper (not shown) may be provided to connect upper rim 36 of the flexible outer bag 28 with lower edge 37 of upper pouch 31.

Upper pouch 31 may be collapsible. Side wall 32 may fold in on itself when upper pouch 31 is empty. When side wall 32 is folded in on itself, a zipper (not shown) may be provided around the circumference of side wall 32 to connect the upper portion of side wall 32, proximate to upper rim 38, to the lower portion of side wall 32, proximate to lower edge 37.

Upper pouch 31 may comprise porous mesh or any flexible non-porous material.

A cover 22 may be attached to the upper pouch 31 along upper rim 38. The cover 22 may be configured to cover and close enclosable space 26. The cover 22 may comprise a flexible or rigid material. A zipper (not shown) may be provided to connect edge 39 of cover 22 with upper rim 38 of upper pouch 31. Moreover, a handle (not shown) may be added to the top of cover 22 for convenience in carrying the flexible component 20.

A pocket 40 may be provided on the inside of cover 22 for storing extra materials. The pocket 40 may comprise porous mesh or a non-porous material and may be any size or shape. The pocket 40 may be closeable using a zipper, button, or any other conventional closing means.

Preferably, the flexible component 20 is approximately 19 1/2 inches tall, in its fully expanded state, by 10 1/2 inches in diameter and can hold approximately up to 10 lbs of ice or other material. Additional sizes and/or dimensions may be offered.

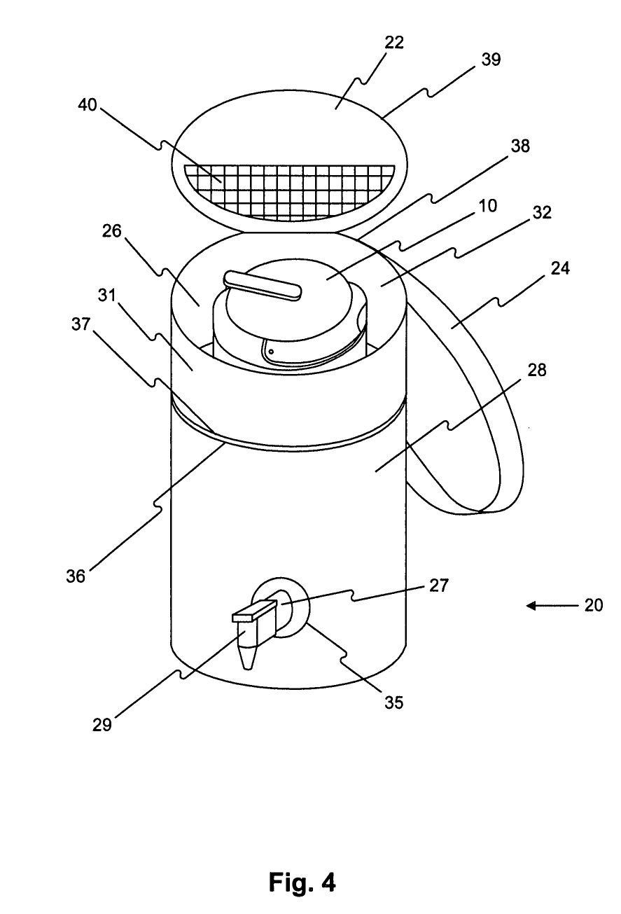

In accordance with the invention, the container system includes both a rigid container and a flexible component. As embodied herein and depicted in FIG. 4, the rigid container 10 may be placed within the upper pouch 31 of the flexible component 20 when the user will not be able to access a refrigeration unit (not shown) for a long time. The rigid container 10 and the flexible component 20 together provide a means of maintaining the cooled state of the rigid container 10 once the flexible component 20 is filled with ice.

When a user plans to go to a disaster area, a remote area, or any area where a refrigeration unit is not readily available, the user may, before leaving for the area, place the rigid container 10 in a refrigeration unit to activate the insulating material 13, 15. When the insulating material 13, 15 is activated to a desired state, the user may remove the rigid container 10 from the refrigeration unit. The user then may remove the lid 12 by grasping member for gripping 102, pulling the latch 19 away from the corresponding hollow 17. The user then may twist upper storage portion 16 with respect to lower insulated storage portion 18 to separate them. The user may then fill the lower storage area 109 with labile medications or other materials whose temperatures must be controlled. The user may then twist the upper storage portion 16 and the lower insulated storage portion 18 back together and place other useful, non-labile materials in the upper storage area 11. The user may then replace the lid 12.

Additionally, the user may open the flexible outer bag 28 of the flexible component 20 by, for example, unzipping the zipper that connects upper rim 36 to lower edge 37. The user may fill the porous inner bag 23 with ice. The user may fill porous inner bag 23 while it sits inside flexible outer bag 28, or the user may remove porous inner bag 23 from flexible outer bag 28, fill it with ice, and then replace it inside flexible outer bag 28. The user may then cover and close the flexible outer bag 28 with the upper pouch 31. The user may then open cover 22 and place the cooled, assembled rigid container 10 into the upper pouch 31 of the flexible component 20 and close the cover 22 of the flexible component 20. The entire system can then be carried using the carrying straps 24 in the backpack, duffle, or over-the-shoulder position, or the system can be carried by the top handle (not shown) by adjusting the straps.

The user may take the entire system into a remote area, evacuation facility, or safe building. Alternatively, the user may use either the rigid container 10 or the flexible component 20 separately. As the ambient temperature melts the ice inside the flexible component 20, the water may seep through the porous inner bag 23 into the space (not shown) between the porous inner bag 23 and the flexible outer bag 28. As needed, the user may then open the shutoff valve 29 to access the water for drinking or for other uses. Meanwhile, the ice inside the flexible component 20 and the insulating material 13, 15 help to keep the labile materials inside the lower storage area 109 cold. As needed, the user may access the inside of the flexible outer bag 28 through the upper pouch 31 and may access the inside of the upper pouch 31 through the cover 22. The user may also access the materials inside the upper storage area 11 and the lower storage area 109.

When the upper pouch 31 is not in use, the user may collapse upper pouch 31 and keep it collapsed, for example, by zipping the zipper that connects the upper portion of side wall 32 to the lower portion of side wall 32. Also, when the user is not using the flexible component 20 at all, the user may collapse the entire flexible component 20 and store it in a separate duffel bag (not shown).

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A container system having a rigid container comprising:
a lower insulated storage portion having an upper opening for removably containing labile material;
an upper storage portion removably attached to the lower insulated storage portion and configured to close the upper opening of the lower insulated storage portion and insulate the lower insulated storage portion;
a lid removably disposed on the upper storage portion; and
a carry handle connected to the upper storage portion for selectively carrying the assembled rigid container.

2. The container system of claim 1 wherein the lower insulated storage portion comprises a side wall and a bottom wall defining a lower storage area.

3. The container system of claim 2 wherein the side wall comprises two parallel walls defining a void for containing an insulating material.

4. The container system of claim 3 wherein the insulating material is a coolant gel.

5. The container system of claim 1 wherein the lower insulated storage portion and the upper storage portion are substantially cylindrical.

6. The container system of claim 2 wherein the lower storage area is divided into sections.

7. The container system of claim 1 wherein the upper storage portion defines an upper storage area that is divided into sections.

8. The container system of claim 1 wherein the upper storage portion is configured to store temperature-sensitive items.

9. The container system of claim 1 wherein the upper storage portion comprises a collar surrounding the upper storage area, the collar including a recess for receiving the carry handle, which is disposed to be pivotally moved between a recessed position and an extended position.

10. The container system of claim 1 further comprising a gasket disposed between the upper storage portion and the lower insulated storage portion.

11. The container system of claim 2 wherein the upper storage portion includes a pair of opposed radially-projecting lugs proximate to the bottom of the upper storage portion, and the lower insulated storage portion includes a pair of notches disposed to receive in locking engagement the complementary radially-projecting lugs.

12. A container system having a flexible component comprising:
a flexible outer bag with a closeable opening defining a space for containing a liquid;
a porous inner bag that is removably disposed inside the flexible outer bag for containing ice; and
an upper pouch of flexible material, attached to the flexible outer bag, for containing a rigid container.

13. The container system of claim 12 further comprising a tube providing fluid communication with the space between the porous inner bag and the flexible outer bag for selectively removing water accumulating therein.

14. The container system of claim 13 wherein the tube includes a shutoff valve for transporting water out of the flexible component.

15. The container system of claim 12 wherein the flexible outer bag comprises at least two layers of material for providing additional insulation.

16. The container system of claim 12 wherein the upper pouch comprises a side wall and a bottom wall defining an upper compartment.

17. The container system of claim 16 wherein the side wall is collapsible.

18. The container system of claim 16 wherein the upper pouch comprises a closeable lid configured to cover and close the upper compartment.

19. The container system of claim 12 wherein the upper pouch is configured to cover and close the space for containing a liquid.

20. A container system including a rigid container and a flexible component comprising:
a lower insulated storage portion having an upper opening for removably containing labile material;
an upper storage portion removably attached to the lower insulated storage portion and configured to close the upper opening of the lower insulated storage portion and insulate the lower insulated storage portion;
a lid removably disposed on the upper storage portion;
a carry handle connected to the upper storage portion for selectively carrying the assembled rigid container;
a flexible outer bag with a closeable opening defining a space for containing a liquid;
a porous inner bag that is removably disposed inside the flexible outer bag for containing ice; and
an upper pouch of flexible material, attached to the flexible outer bag, for containing a rigid container.
